(19) United States
(12) Patent Application Publication
(10) Pub. No.: US 2021/0122382 A1
(43) Pub. Date: Apr. 29, 2021

(54) VEHICLE ABNORMALITY INSPECTION SYSTEM

(71) Applicant: TOYOTA JIDOSHA KABUSHIKI KAISHA, Toyota-shi (JP)

(72) Inventors: Ryosuke OYA, Toyota-shi (JP); Keiji KISHIDA, Toyoake-shi (JP)

(21) Appl. No.: 16/934,091

(22) Filed: Jul. 21, 2020

(30) Foreign Application Priority Data
Oct. 25, 2019 (JP) 2019-193913

(51) Int. Cl. B60W 50/02; G08G 1/017

(52) U.S. Cl. CPC B60W 50/0205; B60W 2555/20; G08G 1/017

(57) ABSTRACT

A data collection system for inspection includes a communication unit that communicates with a plurality of vehicles, a selection unit that selects a plurality of target vehicles, and a data collection unit that collects the vehicle data of each target vehicle through the communication unit. The selection unit acquires vehicle environment information for each of the vehicles, assign the vehicle environment information to a plurality of classes, and for each class, obtains a frequency that is the number of the vehicles belonging to the class, and select the target vehicles for each class such that, of the classes, a ratio of the number of vehicles to be selected as the target vehicles to the frequency of each class is smaller in a first class having the frequency equal to or higher than a predetermined reference value than in a second class having the frequency less than the reference value.

### INCORPORATION BY REFERENCE

The disclosure of Japanese Patent Application No. 2019-193913 filed on Oct. 25, 2019 including the specification, drawings and abstract is incorporated herein by reference in its entirety.

### BACKGROUND

### 1. Technical Field

The disclosure relates to a vehicle abnormality inspection system.

### 2. Description of Related Art

As a vehicle abnormality inspection system, a technique has been known that collects time-series data of vehicle operation from the vehicle to learn an evaluation model and detects an abnormality of the vehicle using the obtained evaluation model (for example, see Japanese Unexamined Patent Application Publication No. 2015-026252 (JP 2015-026252).

### SUMMARY

However, when data is collected from the vehicle for use in the vehicle abnormality detection, for example, the vehicle to be targeted for data collection may be used in biased circumstances, and thus in some cases, it may be difficult to secure a desired diversity in the collected data. Furthermore, when the number of vehicles to be targeted for data collection is increased to secure the desired diversity in collected data, it is likely for communication traffic to be enormous during data collection.

The disclosure can be achieved as the following embodiments.

(1) An aspect of the disclosure relates to a data collection system for inspection that collects vehicle data from a plurality of vehicles to perform a vehicle abnormality inspection. The data collection system for inspection includes a communication unit, a selection unit, and a data collection unit. The communication unit is configured to communicate with the vehicles, the selection unit is configured to, from among the vehicles, select a plurality of target vehicles for which the vehicle data is to be collected, and the data collection unit is configured to, from the target vehicles, collect the vehicle data of each target vehicle through the communication unit. The selection unit is configured to acquire vehicle environment information representing a vehicle environment for each of the vehicles, assign the vehicle environment information to a plurality of predetermined classes, and for each class, obtains a frequency that is the number of the vehicles belonging to the class, and select the target vehicles for each class such that, of the classes, a ratio of the number of vehicles to be selected as the target vehicles to the frequency of each class is smaller in a first class having the frequency equal to or higher than a predetermined reference value than in a second class having the frequency less than the reference value. With the data collection system for inspection according to the aspect of the disclosure, it is possible to suppress the bias of the vehicle environments for the selected target vehicles when the target vehicles are selected from the vehicles, thereby making it possible to secure the diversity in vehicle data collected from the target vehicles. Further, since the number of target vehicles for which vehicle data is to be collected can be suppressed, it is possible to suppress an increase in the communication traffic when vehicle data is acquired.

(2) In the data collection system for inspection according to the aspect of the disclosure, the selection unit may be configured to, for the first class, select the number of vehicles equal to the reference value from all vehicles belonging to the first class, as the target vehicles. With the data collection system for inspection according to the aspect of the disclosure, it is possible to secure the number of vehicles belonging to the first class in the target vehicles and suppress the excessive increase in the number of vehicles belonging to the first class, thereby making it easy to secure the diversity in vehicle data collected from the target vehicles.

(3) In the data collection system for inspection according to the aspect of the disclosure, the selection unit may be configured to, for the first class, randomly select the number of vehicles equal to the reference value from all vehicles belonging to the first class, as the target vehicles. With the data collection system for inspection according to the aspect of the disclosure, it is possible to suppress the bias of conditions other than the vehicle environment information related to the class in the target vehicles.

(4) In the data collection system for inspection according to the aspect of the disclosure, the selection unit may be configured to, for the second class, select all vehicles belonging to the second class, as the target vehicles. With the data collection system for inspection of the aspect of the disclosure, in the second class having a relatively low frequency, it is possible to secure the number of target vehicles belonging to the second class to secure the diversity in vehicle data collected from the target vehicles.

(5) In the data collection system for inspection according to the aspect of the disclosure, the vehicle environment may include at least one of an external environment to be used by each of the vehicles and an internal environment related to a state of each of the vehicles itself. With the data collection system for inspection according to the aspect of the disclosure, it is possible to suppress the effects due to the biases of the internal and external environments of the target vehicles when the abnormality inspection for a vehicle is performed using vehicle data collected from the target vehicles, thereby making it possible to increase the accuracy of the inspection.

(6) In the data collection system for inspection according to the aspect of the disclosure, the vehicle environment may include an outside air temperature of an environment used by each of the vehicles as the external environment. With the data collection system for inspection according to the aspect of the disclosure, it is possible to suppress the effects due to the bias of outside air temperature in the target vehicles when the abnormality inspection of a vehicle is performed using vehicle data collected from the target vehicles, thereby making it possible to increase the accuracy of the inspection.

(7) In the data collection system for inspection according to the aspect of the disclosure, the vehicle may be a fuel cell vehicle. With the data collection system for inspection according to the aspect of the disclosure, it is possible to improve the accuracy when the abnormality inspection for the fuel cell vehicle is performed. The disclosure can be implemented in various forms other than the data collection system for inspection. For example, it can be implemented in the form of a data collection method for inspection, a computer program that implements the method, a non-transitory recording medium that records the computer program, or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of an inspection system;

FIG. 2 is a diagram illustrating functional blocks of the inspection system;

FIG. 3 is a process diagram illustrating an operation of collecting vehicle data;

FIG. 4 is a diagram illustrating vehicle environment information;

FIG. 5 is a diagram illustrating a result of analyzing a distribution of the number of vehicles in step T110;

FIG. 6 is another diagram illustrating the result of analyzing the distribution of the number of vehicles in step T110;

FIG. 7 is a flowchart showing a target vehicle selection processing routine; and

FIG. 8 is a flowchart showing a vehicle data transmission processing routine.

### DETAILED DESCRIPTION OF EMBODIMENTS

### A. Configuration of System

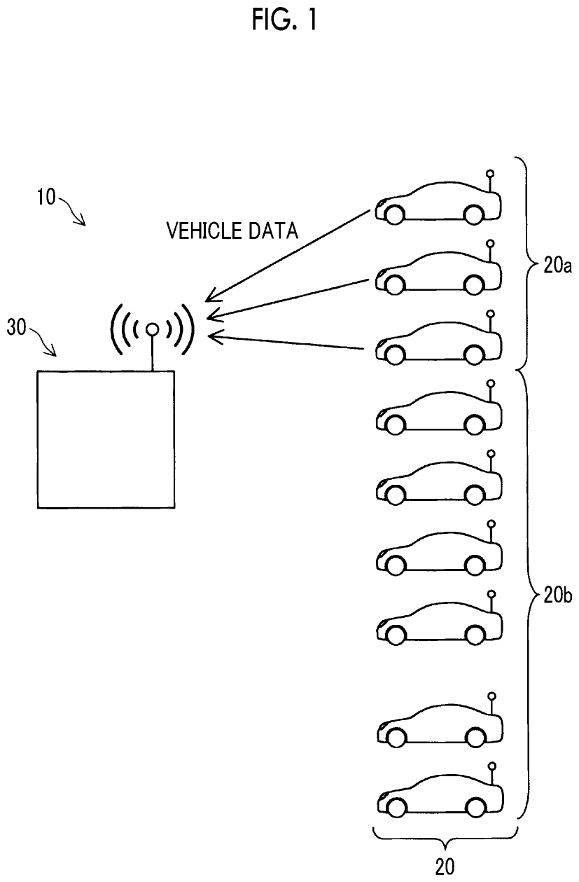

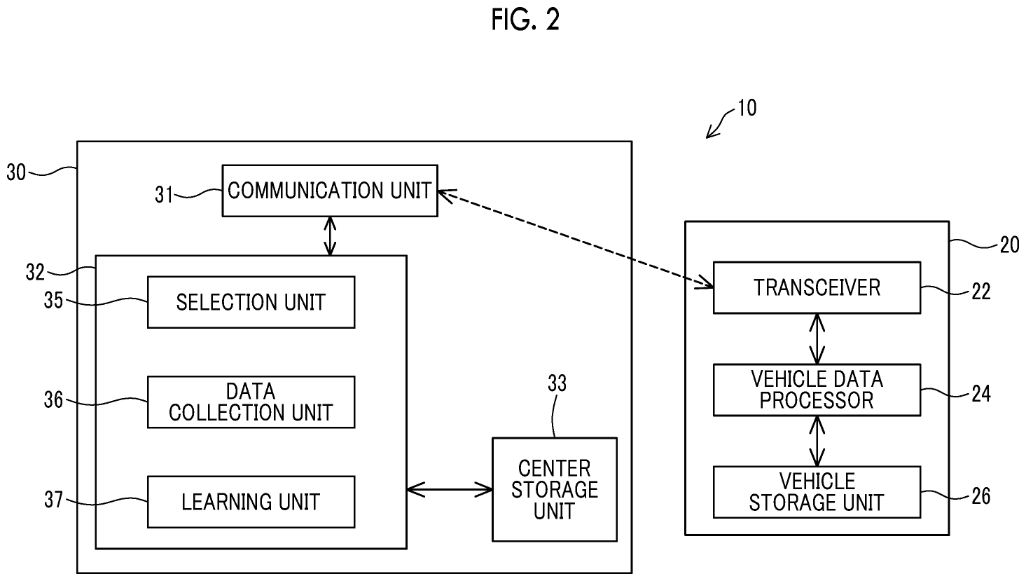

FIG. 1 is a diagram illustrating a schematic configuration of an inspection system 10 for inspecting an abnormality of a vehicle according to an embodiment of the disclosure. Further, FIG. 2 is a diagram illustrating functional blocks of the inspection system 10. Hereinafter, the configuration of the inspection system 10 will be described with reference to FIGS. 1 and 2. The inspection system 10 for inspection according to the embodiment includes a plurality of vehicles 20, and a data collection system 30 for inspection that collects, from the vehicles 20, vehicle data representing a state of each of the vehicles 20 to perform an abnormality inspection on a vehicle to be targeted for inspection.

The vehicle 20 is vehicles that have a function of communicating with the data collection system 30 for inspection and travel in an area where communication with the data collection system 30 for inspection is possible. In FIG. 2, only a single vehicle 20 is shown for the vehicles 20. The vehicle 20 is a vehicle for which the data collection system 30 for inspection may collect vehicle data. The vehicle 20 according to the embodiment is a fuel cell vehicle on which a fuel cell is mounted as one of driving energy sources. The vehicles 20 may be, for example, vehicles having a function of communicating with the data collection system 30 for inspection, of fuel cell vehicles existing in a specific region, a country, or the whole world.

As shown in FIG. 2, the vehicle 20 includes a transceiver 22, a vehicle data processor 24, and a vehicle storage unit 26. In the following description, the individual vehicle 20 itself is also referred to as “host vehicle”. The transceiver 22 is a device for communicating with the data collection system 30 for inspection. The vehicle data processor 24 includes a central processing unit (CPU), a read-only-memory (ROM), a read-access memory (RAM), and an input/output port. The vehicle data processor 24 performs operations of acquiring the vehicle data representing the state of the host vehicle, updating the vehicle data of the host vehicle stored in the vehicle storage unit 26, and transmitting the vehicle data of the host vehicle to the data collection system 30 for inspection. Specifically, as the operation of acquiring the vehicle data, the vehicle data processor 24 performs an operation of continuously acquiring detection results from various sensors provided in various parts of the host vehicle, the details of the instruction input by a user of the host vehicle, and the like. Then, as the operation of updating the vehicle data, the vehicle data processor 24 performs an operation of updating the details of the vehicle data stored in the vehicle storage unit 26 by using the newly acquired vehicle data. Further, as the operation of transmitting the vehicle data, the vehicle data processor 24 performs an operation of transmitting the vehicle data of the host vehicle, which is continuously acquired as described above, and the vehicle data stored in the vehicle storage unit 26 to the data collection system 30 for inspection through the transceiver 22, under a certain condition to be described later.

Here, the vehicle data representing the state of the vehicle may be information including at least one of, for example, vehicle speed, acceleration, navigation information, position information of the vehicle 20, the details of instruction input from the user of the vehicle 20, and detection values from the sensors provided in various parts of the vehicle 20 on which a fuel cell system is mounted. The details of the instruction input from the user of the vehicle 20 may include at least one of operating states of the accelerator and the brake of the vehicle, the operating state of an air conditioner, and an input state to a start switch for instructing start and stop of the fuel cell system. The detection values of the sensors provided in various parts of the vehicle 20 on which the fuel cell system is mounted may include at least one of, for example, a detection value of the sensor that detects the pressure or flow rate of reaction gas supplied to the fuel cell, a detection value of the sensor that detects the temperature and flow rate of refrigerant flowing in the fuel cell, and a detection value of the sensor that detects an output current and an output voltage of the fuel cell.

The vehicle storage unit 26 includes recording media such as a hard disk, a compact disc (CD)-ROM and a digital versatile disc (DVD)-ROM, and a drive device for the recording media. The vehicle storage unit 26 according to the embodiment stores at least a part of the vehicle data of the host vehicle in the memory described above. Specifically, for example, the vehicle data can be stored at least in a partial quantity starting from the present and going back a certain period, that is, from the present to a certain past. In this case, when the vehicle data processor 24 updates the vehicle data in the vehicle storage unit 26, for example, the operation of adding new data may be repeated while discarding the oldest data. Alternatively, when the vehicle data is, for example, an average value of vehicle speed, the operation of calculating the average value by adding the newly detected vehicle speed while discarding the oldest data of the vehicle speed data used for calculating the average value and updating the stored average vehicle speed may be repeated.

The vehicle storage unit 26 may store vehicle environment information representing the vehicle environment of the host vehicle, in addition to the above vehicle data or in place of the vehicle data. Further, at least a part of the vehicle data stored in the vehicle storage unit 26 may be used as the vehicle environment information. The vehicle environment information is used when the data collection system 30 for inspection selects a vehicle for which vehicle data is to be collected from among the vehicles 20. The operation of selecting a vehicle for which the vehicle data is to be collected by using the vehicle environment information will be described in detail later.

The data collection system 30 for inspection has a function of communicating with all the vehicles 20, and collects vehicle data from the vehicles selected from the vehicles 20 to perform an abnormality inspection of the vehicles to be targeted for inspection. As shown in FIG. 2, the data collection system 30 for inspection includes a communication unit 31, a processor 32, and a center storage unit 33.

The communication unit 31 is a device for communicating with each vehicle 20 capable of transmitting vehicle data.

The processor 32 includes a CPU, an ROM, a RAM, and an input/output port. The processor 32 performs operations of selecting a vehicle for which vehicle data is to be acquired from among all the vehicles 20 capable of communicating with the data collection system 30 for inspection, and acquiring vehicle data from the selected vehicle. The processor 32 according to the embodiment further performs an operation of updating an evaluation model stored in the center storage unit 33 to provide the acquired vehicle data for vehicle abnormality inspection.

As shown in FIG. 2, the processor 32 includes a selection unit 35, a data collection unit 36, and a learning unit 37. The selection unit 35 acquires the vehicle environment information regarding all the vehicles 20 capable of communicating with the data collection system 30 for inspection and selects a plurality of vehicles 20 for which vehicle data is to be collected from the vehicles. The vehicle 20 for which the vehicle data is to be collected is also referred to as “target vehicle”. The data collection unit 36 acquires vehicle data of each target vehicle from the selected target vehicles. The learning unit 37 uses the vehicle data newly acquired by the data collection unit 36 to update the evaluation model that is stored in the center storage unit 33 and is used for the abnormality inspection of the vehicle. The vehicle environment information described above and the processing executed by the processor 32 will be described in detail later.

The center storage unit 33 includes a memory, and stores, in the memory, the vehicle environment information regarding each vehicle and the information used for acquiring the vehicle environment information regarding each vehicle. The center storage unit 33 according to the embodiment further stores an evaluation model that is constructed by the data collection unit 36 using the vehicle data acquired from the target vehicles and that is used for the abnormality inspection of the vehicle to be targeted for inspection.

### B. Operation of System

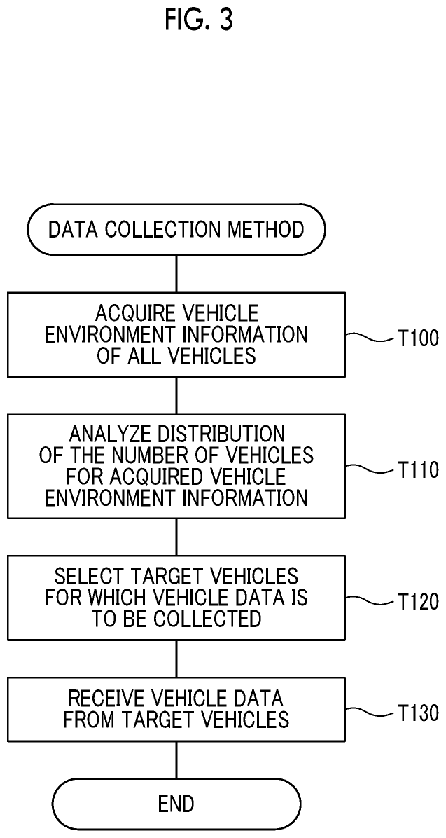

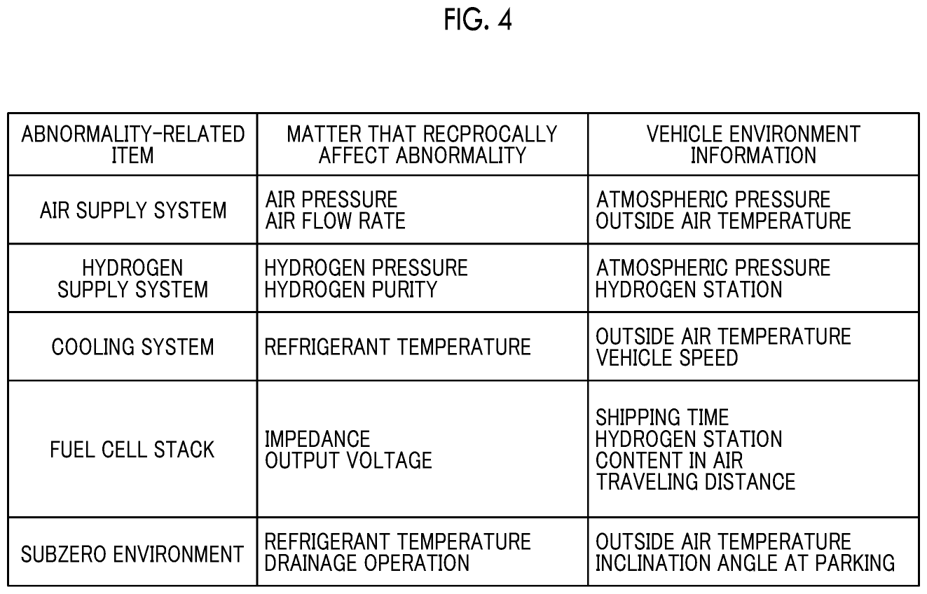

FIG. 3 is a process diagram illustrating an operation of collecting vehicle data from the vehicles 20, which is performed in inspection system 10. When the evaluation model is updated, first, the selection unit 35 of the data collection system 30 for inspection acquires vehicle environment information for each of all vehicles 20 which are communicable with the data collection system 30 (step T100). The vehicle environment information is information representing the vehicle environment of the host vehicle, and the vehicle environment may include at least one of an external environment in which each vehicle is used and an internal environment related to the state of each vehicle itself. The vehicle environment information may affect the vehicle data of each vehicle. Hereinafter, the vehicle environment information will be described with reference to FIG. 4.

FIG. 4 is a diagram illustrating vehicle environment information in the vehicle 20 that is a fuel cell vehicle. In FIG. 4, “abnormality-related items”, “matters that reciprocally affect abnormality”, and “vehicle environment information” are collectively shown. Here, the “abnormality-related item” refers to “a part relating to the occurrence of abnormality” in the vehicle 20 and “a matter that is likely to cause abnormality” in the vehicle 20. In FIG. 4, as examples of the “part related to the occurrence of abnormality”, there are illustrated an “air supply system” for supplying air that is an oxidizing gas to the fuel cell, a “hydrogen supply system” for supplying hydrogen that is a fuel gas to the fuel cell, a “cooling system” related to circulation of a refrigerant that cools a fuel cell and a “fuel cell stack”. Further, in FIG. 4, “subzero environment” is illustrated as the “matter that is highly likely to cause abnormality”.

As illustrated in FIG. 4, the “matters that reciprocally affect abnormality” can be matters corresponding to any in the “abnormality-related item” described above. The “matters that reciprocally affect abnormality” includes matters that are affected when abnormality occurs due to the matters that the occurrence of abnormality in each “part related to the occurrence of abnormality” and “matters that are highly likely to cause abnormality”. Examples of the “matters that reciprocally affects abnormality” corresponding to the “air supply system” include the air pressure and the air flow rate supplied to the fuel cell. Examples of the “matters that reciprocally affect abnormality” corresponding to the “hydrogen supply system” include the hydrogen pressure and hydrogen purity supplied to the fuel cell. Examples of the “matters that reciprocally affect abnormality” corresponding to the “cooling system” include the refrigerant temperature for cooling the fuel cell. Examples of the “matters that reciprocally affect abnormality” corresponding to the “fuel cell stack” include the impedance of the fuel cell and the output voltage of the fuel cell. Examples of the “matters that reciprocally affect abnormality” corresponding to the “subzero environment” include the refrigerant temperature and the drainage operation from the fuel cell stack.

As illustrated in FIG. 4, the “vehicle environment information” can include information corresponding to any in the “abnormality-related item” described above. Examples of the vehicle environment information corresponding to the “air supply system” and capable of affecting the air pressure and the air flow rate supplied to the fuel cell, include the atmospheric pressure and the outside air temperature of the environment in which the vehicle 20 is used. Examples of the vehicle environment information corresponding to the “hydrogen supply system” and capable of affecting the hydrogen pressure and hydrogen purity supplied to the fuel cell include the atmospheric pressure of the environment in which the vehicle 20 is used and information indicating a hydrogen station used for filling the vehicle 20 with hydrogen. Since the purity of hydrogen provided may vary depending on the region or operating organization of the hydrogen station used, the information regarding the hydrogen station can be vehicle environment information corresponding to the “hydrogen supply system”. Examples of the vehicle environment information corresponding to the “cooling system” and capable of affecting the refrigerant temperature, include the outside air temperature of the environment in which the vehicle 20 is used and the vehicle speed of the vehicle 20. Examples of the vehicle environment information corresponding to the “fuel cell stack” and capable of affecting the impedance of the fuel cell and the output voltage of the fuel cell include the shipping time of the vehicle 20 (or the fuel cell stack mounted on the vehicle 20), information indicating the hydrogen station used by the vehicle 20 for hydrogen filling, contents in the air of the environment in which the vehicle 20 is used, and the traveling distance of the vehicle 20. For example, the properties of the fuel cell stack may differ depending on the lot of the fuel cell stack and the like. In addition, the degree of deterioration of the fuel cell stack may differ depending on, for example, contents in the air such as sulfur compounds and the traveling distance of the vehicle 20. Therefore, the above information can be vehicle environment information corresponding to the “fuel cell stack”. Examples of the vehicle environment information that corresponds to the “subzero environment” and capable of affecting the refrigerant temperature and the drainage operation from the fuel cell stack includes the outside air temperature of the environment in which the vehicle 20 is used and the inclination angle when the vehicle 20 is parked. The location where the liquid water stays in the fuel cell stack changes depending on the inclination angle of the vehicle 20 when the vehicle is parked, and the liquid water in the fuel cell freezes, and thus the degree to which the performance of the fuel cell changes may change.

Among the vehicle environment information described above by way of example, for example, the atmospheric pressure of the environment in which the vehicle 20 is used, the outside air temperature, the information indicating the hydrogen station used by the vehicle 20 for hydrogen filling, the contents in the air, the inclination angle at parking, or the like, can be regarded as the external environment in which the vehicle is used. In addition, the vehicle speed of the vehicle 20, the shipping time, the traveling distance, and the like can be regarded as the internal environment related to the state of the vehicle itself.

In step T100, the vehicle environment information that the selection unit 35 of the data collection system 30 for inspection acquires for each vehicle may be the information stored in the center storage unit 33, may be information estimated using the information stored in the center storage unit 33, or information acquired from individual vehicles. Hereinafter, as an example, a method of estimating the outside air temperature, which is vehicle environment information, will be described.

For example, the position where the vehicle 20 travels next time and the time zone when the vehicle 20 travels next time are estimated, and the outside air temperature of the environment in which the vehicle 20 is used next time is estimated by using the estimated results. The position where the vehicle 20 will travel next time may be estimated, for example, by using the position information when the position where the vehicle 20 traveled last time is acquired from each vehicle 20 and stored in the center storage unit 33. Alternatively, the vehicle registration location of each vehicle may be stored in the center storage unit 33 in advance, and the vehicle registration location may be estimated as the position at which the vehicle 20 will travel next time. For example, when the center storage unit 33 stores the position where the vehicle 20 traveled last time, the stored position may be estimated as the position where the vehicle 20 will travels next time, and when the position is not stored, the vehicle registration location may be estimated as the position where the vehicle 20 will travel next time. When the time zone in which the vehicle 20 will travels next time is, for example, when the average use time zone is continuously updated using the driving history of each vehicle 20 and stored in the center storage unit 33, the latest information that is stored may be used. Alternatively, when the usage time zone is continuously estimated by performing appropriate weighting by machine learning by using the driving history of each vehicle 20 and stored in the center storage unit 33, the latest stored information may be used. Then, the outside air temperature as the vehicle environment at the time of the next driving may be estimated by using the estimated result of the position where the vehicle 20 will travel next time and the time zone when the vehicle 20 will travel next time. In that case, the past average temperature, weather forecast, or the like, for each region are stored in the center storage unit 33 in advance or newly acquired from outside the data collection system 30 for inspection through the communication unit 31, and the information may be referred to.

The data collection system 30 for inspection may directly acquire, from each vehicle 20, the information that can be acquired by each vehicle 20 as information relating to the current vehicle 20, such as the outside air temperature and the position information, each time step T100 is executed. However, when the information on the mode of the past usage is used as described above to estimate the mode of the next usage, the operation of selecting the vehicle to be targeted for collecting vehicle data more appropriately, which will be described, can be performed more appropriately. This is because it can be considered that the state of the vehicle environment information of the selected vehicle when the vehicle transmits the vehicle data is more accurately represented by the vehicle environment information estimated as described above than by the current vehicle environment information of the vehicle 20.

When the atmospheric pressure is used as the vehicle environment information, for example, the position where the vehicle 20 will travel next time may be estimated in the same manner as the case of the outside air temperature, and the atmospheric pressure of the region where the vehicle 20 will travel next may be estimated with reference to the information indicating the atmospheric pressure for each region stored in advance in the center storage unit 33. When the contents in the air such as a sulfur compound are used as the vehicle environment information, for example, the entire region in which the vehicle 20 can travel may be divided into a plurality of groups according to the difference in the concentration of the content in the air and may be stored in the center storage unit 33. Then, the position where the vehicle 20 will travel next time may be estimated in the same manner as the case of the outside air temperature, and among the divided regions, a region where the vehicle 20 will travel next time belongs to may be estimated with reference to the above-mentioned information regarding divided regions.

When the hydrogen station, the vehicle speed, the traveling distance, and the inclination angle at parking are used as the vehicle environment information, each vehicle 20 stores the pieces of information regarding the host vehicle in the vehicle storage unit 26 while continuously updating the pieces of information. Then, the data collection system 30 for inspection may acquire the pieces of information from each vehicle 20 when the step T100 is executed. Alternatively, the data collection system 30 for inspection may acquire the above information from each vehicle 20 at a predetermined timing and store the information in the center storage unit 33 such that the information can be used when the step T100 is executed. The inclination angle at parking and the like can be estimated, for example, from the detection value of an acceleration sensor provided in the vehicle 20 at the timing when the start switch of each vehicle 20 is ON or OFF. When the shipping time is used as the vehicle environment information, the information may be stored in advance in the center storage unit 33 such that the information can be used when the step T100 is executed.

As described above, in step T100, when the vehicle environment information of all the vehicles for which the vehicle environment information can be acquired is acquired, the selection unit 35 of the data collection system 30 for inspection then analyzes a distribution of the number of vehicles in the acquired vehicle environment information (step T110).

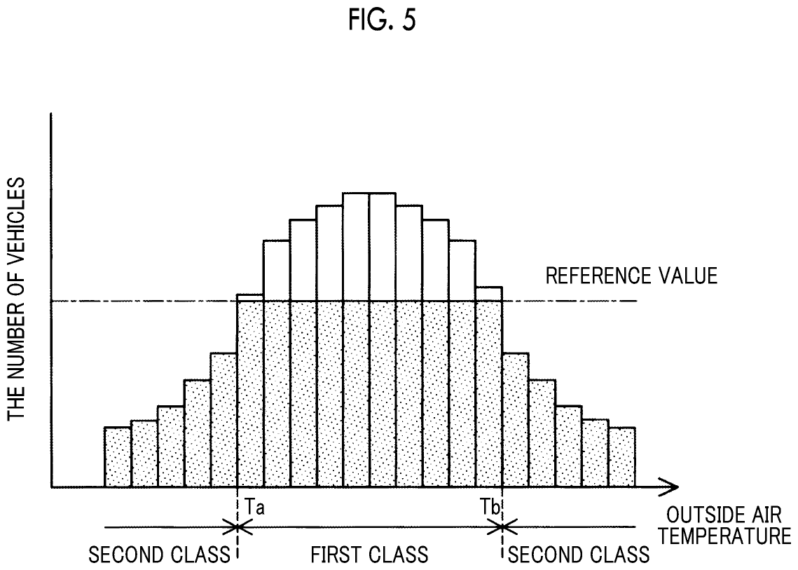

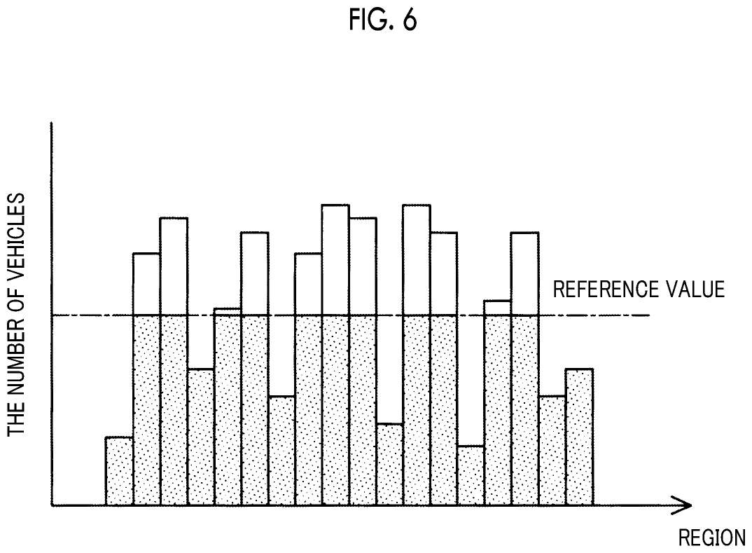

As an example, FIG. 5 illustrates a diagram for results of analyzing the distribution of the number of vehicles in step T110 when the outside air temperature is used as the vehicle environment information. Further, as another example, FIG. 6 illustrates a diagram of results of analyzing the distribution of the number of vehicles in step T110 when information indicating the hydrogen station used for hydrogen filling is used as vehicle environment information.

In FIG. 5, a temperature range that can be taken as the outside air temperature, which is the vehicle environment information, is assigned to a plurality of predetermined classes, and the result of calculating the frequency, which is the number of vehicles belonging to each class is shown for each class. In FIG. 5, the horizontal axis represents the outside air temperature, and the vertical axis represents the number of vehicles belonging to each class. Then, in FIG. 5, the range of outside air temperature that can be taken is divided using a predetermined temperature range as the class range.

When the information indicating the hydrogen station used for hydrogen filling is used as vehicle environment information, for example, the all regions where the hydrogen stations are installed may be assigned to the classes, and the number of vehicles filled with hydrogen at hydrogen stations belonging to each class may be obtained for each class to obtain the distribution of the frequency. FIG. 6 illustrates results of obtaining the frequency, which is the number of vehicles belonging to each class, by defining the class for each region where the hydrogen station is installed as described above. In FIG. 6, the horizontal axis indicates the region and the vertical axis indicates the number of vehicles belonging to each class.

In step T110, when the distribution of the number of vehicles is analyzed with respect to the vehicle environment information, the selection unit 35 of the data collection system 30 for inspection then selects target vehicles for which vehicle data is to be collected (step T120). In step T120, in the embodiment, the classes determined for the vehicle environment information are divided into the first class in which the frequency that is the number of vehicles belonging to the class is equal to or smaller than a predetermined reference value, and the second class in which the frequency of the class is less than the reference value. Then, for each first class, the number of vehicles equal to the reference value is selected as the second vehicle from all the vehicles belonging to the first class. In the embodiment, for the first class, the number of target vehicles equal to the reference value is randomly selected from all the vehicles belonging to each first class. For each second class, all vehicles belonging to the second class are selected as target vehicles. In FIG. 5, each class in which the outside air temperature, which is the vehicle environment information, is in the range of temperatures Ta to Tb is the first class, and the other classes are the second classes. In addition, in FIGS. 5 and 6, the number of vehicles selected as target vehicles is shown by hatching for each class.

In step T120, when the selection unit 35 of the data collection system 30 for inspection selects target vehicles, the data collection unit 36 of the data collection system 30 for inspection receives the vehicle data of each vehicle from each selected target vehicle. (Step T130). FIG. 1 illustrates the state that the vehicles 20 are divided into target vehicles 20a selected in the step T120 and non-target vehicles 20b not selected, and the data collection system 30 for inspection receives the vehicle data from the target vehicles 20a. Hereinafter, the operation related to vehicle data collection will be described separately for an operation in the processor 32 of the data collection system 30 for inspection and an operation in the vehicle data processor 24 of the vehicle 20.

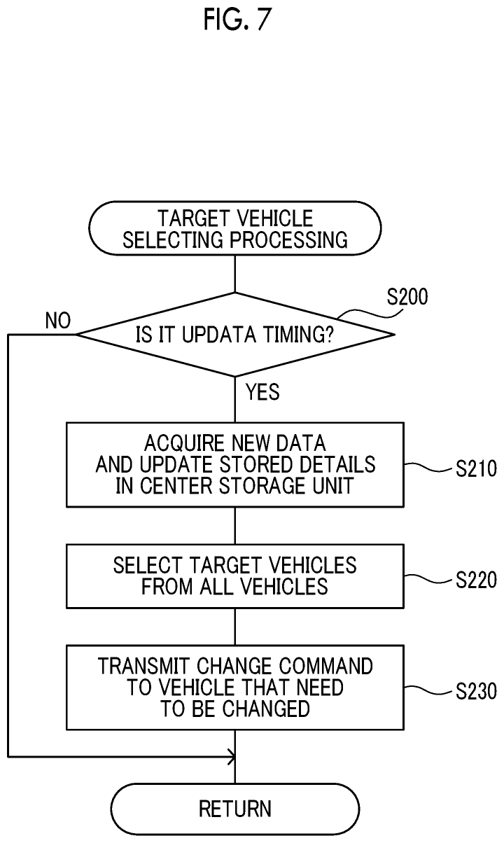

FIG. 7 is a flowchart showing a target vehicle selection processing routine that is repeatedly executed in the processor 32 of the data collection system 30 for inspection. When the routine is activated, the processor 32 determines whether it is the update timing (step S200). As described above, the operation of collecting the vehicle data from the vehicles 20 is performed to update the evaluation model used for the abnormality inspection of the vehicle. The update of the evaluation model is repeatedly executed at a predetermined timing, and in step S200, determination is made whether or not the update timing has been reached with reference to the elapsed time from the previous update. When the determination is that it is not the update timing (NO in step S200), the processor 32 ends the routine.

When determination is made that it is the update timing (YES in step S200), the processor 32 acquires new data and updates the information stored in the center storage unit 33 (step S210). The information stored in the center storage unit 33, which is updated in step S210, is the information referred to when the vehicle environment information of the vehicle described above is acquired. Specifically, for example, when the outside air temperature is estimated as the vehicle environment information as described above, the information on the last traveled position is acquired from each vehicle 20 when the information acquired by the GPS of each vehicle 20 and stored in the vehicle storage unit 26 is obtained as the position where the vehicle 20 traveled last time. When there is a newly registered vehicle 20 after the previous update timing, the vehicle registration location of the vehicle 20 is acquired and newly stored in the center storage unit 33. In this way, the information regarding the driving history of each vehicle 20 after the previous update timing may be acquired from each vehicle 20, and the information regarding the usage time zone stored in the center storage unit 33 may be updated. Further, when new information regarding the average temperature and weather forecast of each area is input, the stored details in the center storage unit 33 relating to the above-mentioned factors may be updated. Since data transmission from the vehicles 20 to the data collection system 30 for inspection is possible when the vehicles 20 are activated, the vehicles 20 that are not activated during the period in which the processor 32 performs the operation of step S210 do not receive data during execution of step S210.

After step S210, the processor 32 selects the target vehicles 20a from all the vehicles (step S220). The processing executed in step S220 is a processing corresponding to each operation of the steps T100 to T120 in FIG. 3 described above, and thus detailed description thereof will not be repeated. For example, when the outside air temperature is used as the vehicle environment information, the target vehicles 20a are selected as illustrated in FIG. 5.

When the target vehicles 20a are selected in step S220, the processor 32 transmits a change command to a vehicle that needs to be changed between the target vehicle 20a and the non-target vehicle 20b (step S230), and ends the routine. That is, among the vehicles that have been the target vehicles 20a until now, a signal notifying that the vehicle is to be changed to the non-target vehicle 20b is transmitted to the vehicles that are not selected as the target vehicles 20a in the target vehicle selection processing routine executed this time. Further, among the vehicles that have been non-target vehicles 20b until now, a signal notifying that the vehicle is to be changed to the target vehicle 20a is transmitted to the vehicles that are selected as the target vehicles 20a in the target vehicle selection processing routine executed this time. Here, since the vehicle 20 cannot receive any of the above-mentioned signals unless the vehicle 20 is activated, the signals may be transmitted until the vehicle to be transmitted receives the signals, for example. The state of the target vehicle 20a, to which the notification that the vehicle is to be the target vehicle 20a has been sent and is capable of transmitting the vehicle data to the data collection system 30 for inspection, is also referred to as an “active state”. Further, the state of the non-target vehicle 20b, to which the notification that the vehicle is to be the non-target vehicle 20b has been sent and does not transmit the vehicle data to the data collection system 30 for inspection is also referred to as an “inactive state”.

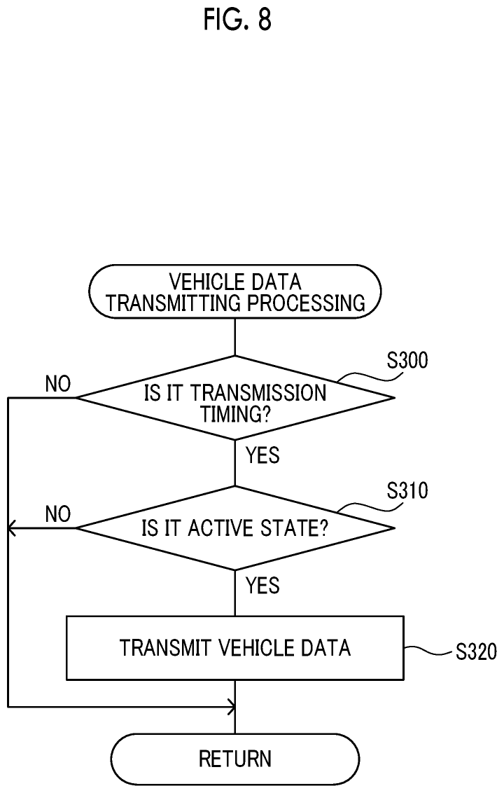

FIG. 8 is a flowchart showing a vehicle data transmission processing routine that is repeatedly executed by the vehicle data processor 24 of the vehicle 20. When the routine is activated, the vehicle data processor 24 determines whether or not it is time to transmit vehicle data (step S300). In the vehicle 20, a transmission timing at which vehicle data is to be transmitted is set in advance, and the target vehicle 20a repeatedly transmits the vehicle data through the transceiver 22 at a predetermined time interval. In step S300, determination is made whether or not it is the transmission timing. When determination is made that it is not the transmission timing (NO in step S300), the vehicle data processor 24 ends the routine.

When determination is made that it is the transmission timing (YES in step S300), the vehicle data processor 24 determines whether or not the host vehicle is in the active state (step S310). When determination is made that the host vehicle is in the inactive state (NO in step S310), the vehicle data processor 24 ends the routine.

When determination is made that the state of the host vehicle is the active state (YES in step S310), the vehicle data processor 24 performs transmission of vehicle data through the transceiver 22 (step S320), and ends the routine. By repeatedly executing the processing of the vehicle data transmission described above, the vehicle 20 in the active state (target vehicle 20a) repeats the operation of transmitting the vehicle data at each transmission timing of a predetermined time interval. Such a target vehicle 20a repeats the operation of transmitting the vehicle data until the state is changed to inactive or the system of the vehicle is stopped. The stored detail indicating that the vehicle 20 is set in the active state is held in the vehicle storage unit 26 of the host vehicle. Therefore, when the vehicle 20 is once stopped and then reactivated, the operation of repeatedly transmitting the vehicle data is performed by repeatedly executing the processing of FIG. 8. The processing of step S300 and the processing of step S310 may be executed in reverse order or may be executed simultaneously.

As described above, when the vehicle data is repeatedly transmitted from the selected target vehicles 20a, in the processor 32 of the data collection system 30 for inspection that receives the vehicle data, the learning unit 37 performs learning using newly acquired vehicle data and updates the evaluation model stored in the center storage unit 33 for use in the abnormality inspection of the vehicle. The evaluation model is constructed by accumulating vehicle data of the vehicles 20 as described above, and is used as a reference for deciding whether the vehicle is a normal vehicle or an abnormal vehicle exhibiting a property outside the normal range. The evaluation model, which is updated using the vehicle data, which is time-series data transmitted from the target vehicles 20a, may be a model that shows a tendency of changes in the vehicle state over time when the vehicle is normal (the tendency of vehicle operation). When an abnormality inspection of the vehicle is performed, a specific type of vehicle data is acquired from the vehicle to be targeted for inspection, and when the acquired vehicle data is compared to the evaluation model and is out of the normal range by the evaluation model, determination is made that the vehicle to be targeted for inspection is abnormal. The vehicle to be targeted for abnormality inspection abnormality using such an evaluation model can be at least a part of all the vehicles 20. The vehicle to be targeted for abnormality inspection can be, for example, a vehicle used by a contractor who has a contract with an organization that performs the abnormality inspection using the evaluation model.

Depending on the type of abnormality to be decided by the evaluation model, the type of vehicle data used for construction, update, and abnormality inspection of the evaluation model is appropriately selected. For example, in order to decide the abnormality of an air supply system, the evaluation model can be constructed and updated by using vehicle data including numerical values representing the pressure and flow rate of the air supplied to the fuel cell, which are matters that reciprocally affect the abnormality. (See FIG. 4). In the embodiment, when the vehicle data used for updating such an evaluation model is collected, the vehicles for which vehicle data is to be collected are narrowed down by using vehicle environment information determined according to the type of abnormality to be decided by the evaluation model. For example, in order to update the evaluation model for deciding the abnormality of the air supply system, the target vehicles 20a for which vehicle data is to be collected may be narrowed down by using, as the vehicle environment information, the atmospheric pressure or the outside air temperature of the environment in which the vehicles 20 are used (see FIG. 4). For example, as shown in FIG. 4, the outside air temperature as the vehicle environment information is related to various abnormalities related to the fuel cell vehicle, such as an abnormality in the air supply system, an abnormality in the cooling system, and an abnormality related to the subzero temperature environment. Therefore, when the target vehicles 20a are narrowed down by using the outside air temperature as the vehicle environment information and vehicle data is collected, the evaluation model for inspecting various abnormalities related to the fuel cell vehicle can be updated. By repeating the operation of collecting vehicle data and repeating the update of the evaluation model as described above, the accuracy of deciding the abnormality using the evaluation model can be improved.

According to the data collection system 30 for inspection of the embodiment configured as described above, when the target vehicles 20a for which the vehicle data used for updating the evaluation model to be collected are narrowed down, the vehicle environment information is acquired from each vehicle 20, the vehicle environment information is assigned to the predetermined classes, and the frequency, which is the number of vehicles belonging to the class, is obtained for each class. Then, among the above-mentioned classes, for the first class in which the frequency is equal to or higher than the reference value, the number of vehicles equal to the reference value is selected as the target vehicles 20a from all the vehicles belonging to the first class. In addition, of the above-mentioned classes, for the second class in which the frequency is less than the reference value, all the vehicles belonging to each second class are selected as the target vehicles 20a. For this reason, when the target vehicles 20a for which vehicle data is to be collected are narrowed down, it is possible to suppress the bias of the vehicle environment for the selected target vehicles 20a. That is, it becomes easy to secure the diversity in the vehicle data collected from the target vehicles 20a. The accuracy of the abnormality inspection can be improved by using the evaluation model updated by using the vehicle data for which the diversity is secured. For example, it is possible to suppress a case where a normal vehicle is erroneously decided as abnormal. Further, since the target vehicles 20a are selected while the bias of the vehicle environment for the target vehicles 20a is suppressed as described above, the need to increase the number of target vehicles 20a to secure the diversity in the collected vehicle data is suppressed, and as a result, the increase in communication traffic when vehicle data is acquired can be suppressed.

### C. Other Embodiments

(C1) Modification of Selection Mode of Target Vehicle

In the embodiment, when the target vehicles 20a are selected, for the first class in which the frequency is equal to or higher than the reference value, the number of vehicles equal to the reference value is selected as the target vehicles 20a from all the vehicles belonging to the first class. However, different configurations may be used. That is, the reference value for dividing the first class and the second class and the number of vehicles selected as the target vehicle 20a for each first class may be different values. Further, in the embodiment, for the second class in which the frequency is less than the reference value, all the vehicles belonging to each second class are selected as the target vehicles 20a. However, different configurations may be used. That is, some of the vehicles belonging to each second class may be selected as the target vehicles 20a. When the target vehicles are selected for each of the classes such that the ratio of the number of vehicles selected as the target vehicles to the frequency of each class is smaller in the first class than that in the second class, the effect of ensuring the diversity in the vehicle data collected from the target vehicles can be obtained, as in the embodiment.

Further, in the embodiment, when the target vehicles 20a are selected for each first class, the target vehicles are randomly selected, from the vehicles belonging to the first class. In such a case where the selection is made randomly, the bias of conditions other than the vehicle environment information related to the class can be suppressed in the selected target vehicles 20a. However, different configurations may be used. For example, the frequency of being selected as the target vehicles 20a in the past may be stored for each vehicle 20, and the vehicle 20 having a low frequency of being selected may be preferentially selected as the target vehicles 20a.

(C2) Modification of Vehicle Environment Information Used to Select Target Vehicle

In the embodiment, for any of the pieces of vehicle environment information, the distribution of the frequency, which is the number of vehicles belonging to the class, is checked for each predetermined class, and the target vehicles 20a are selected for each class. However, different configurations may be used. For example, the target vehicle 20a may be narrowed down by combining a plurality of types of vehicle environment information. When the target vehicles 20a are narrowed down using the types of vehicle environment information, for example, the target vehicles 20a can be narrowed down for each vehicle environment information by obtaining the frequency of each class in the same manner as in the embodiment, and the entire target vehicles 20a selected for each piece of vehicle environment information can be added together to be decided as the vehicles for which vehicle data is to be collected. In this case, the operation of selecting the target vehicles 20a from each first class for each piece of vehicle environment information may be performed, for example, randomly as in the embodiment. With this configuration, it is possible to suppress the bias related to each of the types of vehicle environment information to be used, and to decide the vehicle for which the vehicle data is to be collected.

Alternatively, the target vehicles 20a may be selected in a different manner between main vehicle environment information, which is one of a plurality of types of vehicle environment information, and sub vehicle environment information, which is vehicle environment information other than the main vehicle environment information. Specifically, for the main vehicle environment information, the frequency for each class may be obtained in the same manner as in the embodiment, and the target vehicles 20a may be narrowed down randomly. Then, for the sub vehicle environment information, when the target vehicles 20a are selected from each first class in each sub vehicle environment information, the vehicles selected as the target vehicles with respect to the main vehicle environment information may be preferentially selected as the target vehicles. Then, the target vehicles obtained by adding all the target vehicles 20a selected for each of the main vehicle environment information and the sub vehicle environment information may be decided as the vehicle for which vehicle data is to be collected. With this configuration, the number of vehicles finally decided as the target vehicles 20a can be suppressed, and the communication traffic when vehicle data is collected from the target vehicles 20a can be suppressed.

(C3) Modification of Update Timing

In the embodiment, the update timing determined in step S200 of FIG. 7 is when the predetermined time has elapsed from the previous update, but different configurations may be used. For example, when the number of vehicles belonging to the second class, in which the number of target vehicles 20a for which vehicle data is to be collected is relatively small, increases, the update frequency of reselecting new target vehicles 20a may be increased. Specifically, for example, when the vehicle environment information is the outside air temperature, generally, as shown in FIG. 5, due to the small number of vehicles belonging to a class where the outside air temperature is relatively low and a class where the outside air temperature is relatively high, the number of selected target vehicles 20a is relatively small. In addition, in a season such as summer when the outside air temperature is likely to rise, it is easy to secure the number of target vehicles 20a in a class where the outside air temperature is relatively high, and in the season such as winter when the outside air temperature is likely to be low, it is easy to secure the number of target vehicles 20a in a class where the outside air temperature is relatively low. Therefore, by increasing the frequency of reselecting the target vehicles 20a at a time when it is easy to secure the number of target vehicles 20a for any of the classes in which the number of target vehicles 20a is likely to decrease, such as in summer or winter, the diversity in vehicle data collected from target vehicles 20a can be easily secured, and the accuracy of the abnormality inspection using the updated evaluation model can be improved.

(C4) Modification of System Configuration

In the embodiment, the data collection system 30 for inspection includes, as the processor 32, a communication unit 31 that communicates with a vehicle, a selection unit 35 that performs a processing of selecting the target vehicle, and a data collection unit that collects vehicle data transmitted by the target vehicle, and further includes a learning unit 37 that updates an evaluation model by learning using the newly acquired vehicle data and a center storage unit 33 integrally, but different configurations may be used. At least one of the above-mentioned constituent elements may be provided as a separate body and may be connected to exchange information with each other. Further, the abnormality inspection using the updated evaluation model and the vehicle data acquired from the vehicle to be targeted for inspection may be performed in the data collection system 30 for inspection, and may be performed by another system that can access the updated evaluation model.

(C5) Modification of Vehicle

In the above embodiment, the vehicle 20 to be targeted for acquiring the vehicle environment information and the vehicle data and the vehicle to be targeted for performing abnormality inspection using the updated evaluation model are the fuel cell vehicles, but may have different configurations. In addition to the fuel cell vehicle, the disclosure is applicable to various vehicles, such as an electric vehicle on which a battery is mounted as a driving energy source, a hybrid vehicle on which a battery and an internal combustion engine are both mounted, a vehicle on which an internal combustion engine is mounted as a driving energy source. Depending on the type of vehicle to be targeted for abnormality inspection, and the type of abnormality that can occur in the vehicle and that is related to the inspection, the vehicle environment information may be appropriately set, and the needed vehicle information may be acquired from the selected target vehicles.

The disclosure is not limited to the above-described embodiments, and can be carried out by various configurations without departing from the spirit thereof. For example, the technical features of the embodiment corresponding to the technical features in each mode described in the section of Summary can be appropriately replaced or combined to solve some or all of the above problems, or achieve some or all of the above-described effects. If the technical features are not described as essential in the present specification, the technical features can be deleted as appropriate.

What is claimed is:

1. A data collection system for inspection that collects vehicle data from a plurality of vehicles to perform a vehicle abnormality inspection, the data collection system comprising:
a communication unit configured to communicate with the vehicles;
a selection unit configured to, from among the vehicles, select a plurality of target vehicles for which the vehicle data is to be collected; and
a data collection unit configured to, from the target vehicles, collect the vehicle data of each target vehicle through the communication unit, wherein
the selection unit is configured to:
acquire vehicle environment information representing a vehicle environment for each of the vehicles;
assign the vehicle environment information to a plurality of predetermined classes, and for each class, obtains a frequency that is the number of the vehicles belonging to the class; and
select the target vehicles for each class such that, of the classes, a ratio of the number of vehicles to be selected as the target vehicles to the frequency of each class is smaller in a first class having the frequency equal to or higher than a predetermined reference value than in a second class having the frequency less than the reference value.

2. The data collection system according to claim 1, wherein the selection unit is configured to, for the first class, select the number of vehicles equal to the reference value from all vehicles belonging to the first class, as the target vehicles.

3. The data collection system according to claim 2, wherein the selection unit is configured to, for the first class, randomly select the number of vehicles equal to the reference value from all vehicles belonging to the first class, as the target vehicles.

4. The data collection system according to claim 1, wherein the selection unit is configured to, for the second class, select all vehicles belonging to the second class, as the target vehicles.

5. The data collection system according to claim 1, wherein the vehicle environment includes at least one of an external environment to be used by each of the vehicles and an internal environment related to a state of each of the vehicles.

6. The data collection system according to claim 5, wherein the vehicle environment includes an outside air temperature of an environment used by each of the vehicles as the external environment.

7. The data collection system according to claim 1, wherein the vehicle is a fuel cell vehicle.

8. A data collection method for inspection, in which vehicle data is collected from a plurality of vehicles to perform a vehicle abnormality inspection, the method comprising:
selecting, from among the vehicles, a plurality of target vehicles for which the vehicle data is to be collected; and
collecting the vehicle data of each target vehicle from the target vehicles, wherein the selecting of the target vehicles includes:
acquiring vehicle environment information representing a vehicle environment for each of the vehicles;
assigning the vehicle environment information to a plurality of predetermined classes, and for each class, and obtaining a frequency that is the number of the vehicles belonging to the class; and
selecting the target vehicles for each class such that, of the classes, a ratio of the number of vehicles selected as the target vehicles to the frequency of each class is smaller in a first class having the frequency equal to or higher than a predetermined reference value from the classes than in a second class having the frequency less than the reference value.
